(19) United States
(12) Patent Application Publication
(10) Pub. No.: US 2015/0187265 A1
(43) Pub. Date: Jul. 2, 2015

(54) AMOLED DISPLAY PANEL AND ORGANIC LIGHT EMITTING DIODE DISPLAY DEVICE

(71) Applicants: Xiamen Tianma Micro-Electronics Co., Ltd., Xiamen (CN); Tianma Micro-Electronics Co., Ltd., Shenzhen (CN)

(72) Inventors: Tong ZHANG, Xiamen (CN); Dong QIAN, Xiamen (CN); Hanyu Gu, Xiamen (CN)

(21) Appl. No.: 14/306,172

(22) Filed: Jun. 16, 2014

(30) Foreign Application Priority Data
Dec. 31, 2013 (CN) 201310755024.3

(51) Int. Cl. G09G 3/32

(52) U.S. Cl. CPC G09G 3/3233; G09G 3/3283; G09G 2300/0426; G09G 2300/0814; G09G 2310/0272

(57) ABSTRACT

An AMOLED display panel and an organic light emitting diode display device are disclosed. The AMOLED display panel includes: a multitude of pixel circuits; a multitude of data lines coupled to the pixel circuits; a driver unit, which is configured to provide a first data signal; a multipath selection unit, which is connected between the data lines and the driver unit, and configured to transmit the first data signal to the selected data line; and a voltage stabilizer unit, which is connected to the data lines, and configured to output a second signal to the data lines; wherein, before a data writing stage, the second signal outputted from the voltage stabilizer unit is applied to the data lines. The number of wired data lines in the AMOLED display panel and the volume of the display panel are reduced, and the manufacturing process of the display panel is simplified.

### CROSS-REFERENCES TO RELATED APPLICATIONS

This application claims the benefit of priority to Chinese Patent Application No. 201310755024.3, filed with the Chinese Patent Office on Dec. 31, 2014 and entitled “AMOLED DISPLAY PANEL AND ORGANIC LIGHT EMITTING DIODE DISPLAY DEVICE”, the content of which is incorporated herein by reference in its entirety.

### TECHNICAL FIELD

The present disclosure relates to the field of display technologies, in particular to an Active Matrix/Organic Light Emitting Diode (AMOLED) display panel and an organic light emitting diode display device.

### BACKGROUND OF THE INVENTION

AMOLED display devices are popular nowadays. An AMOLED display device comprises an AMOLED display panel, however, the border width of AMOLED display panel is large.

### BRIEF SUMMARY OF THE INVENTION

In view of the above, embodiments of the present invention provide an AMOLED display panel and an organic light emitting diode display device.

One inventive aspect is an AMOLED display panel including: a multitude of pixel circuits; a multitude of data lines coupled to the pixel circuits; a driver unit, which is configured to provide a first data signal; a multipath selection unit, which is connected between the data lines and the driver unit and configured to transmit the first data signal to the selected data line; and a voltage stabilizer unit, which is connected to the data lines and configured to output a second data signal to the data lines, where, before a data writing stage, the second data signal outputted from the voltage stabilizer unit is applied to the data lines.

Another inventive aspect is an organic light emitting diode display device, including an AMOLED display panel. The AMOLED display panel includes: a multitude of pixel circuits; a multitude of data lines coupled to the pixel circuits; a driver unit, which is configured to provide a first data signal; a multipath selection unit, which is connected between the data lines and the driver unit and configured to transmit the first data signal to the selected data line; and a voltage stabilizer unit, which is connected to the data lines and configured to output a second data signal to the data lines, where, before a data writing stage, the second data signal outputted from the voltage stabilizer unit is applied to the data lines.

### BRIEF DESCRIPTION OF THE DRAWINGS

The accompanying drawings, which form a part of the present disclosure, are used for describing the present disclosure, but are not intended to limit the present invention. Herein,

FIG. 1 is a schematic diagram showing the structure of an AMOLED display panel according to an embodiment of the present invention;

FIG. 1A is a schematic diagram showing the structure of a voltage stabilizer unit of the AMOLED display panel according to an embodiment of the present invention;

FIG. 1B is a schematic diagram showing the structure of the voltage stabilizer unit in which MOS transistors are used as switches according to an embodiment of the present invention;

FIG. 1C is a schematic structural diagram showing another embodiment of the present invention;

FIG. 1D is a schematic diagram showing the structure of a multipath selection unit of the AMOLED display panel according to an embodiment of the present invention;

FIG. 1E is a timing diagram of a control signal and selection signals of the AMOLED display panel according to an embodiment of the present invention;

FIG. 2 is a schematic diagram showing the structure of a pixel circuit in the AMOLED display panel according to another embodiment of the present invention;

FIG. 2A is a schematic driving timing diagram of a pixel circuit according to another embodiment of the present invention;

FIG. 3 is a schematic diagram showing the structure of a pixel circuit in the AMOLED display panel according to another embodiment of the present invention;

FIG. 3A is a schematic timing diagram of a pixel circuit driver according to another embodiment of the present invention; and

FIG. 4 is schematic structural diagram of an organic light emitting diode display device according to another embodiment of the present invention.

### DETAILED DESCRIPTION OF THE INVENTION

The present disclosure will be described below in detail in conjunction with the accompanying drawings and specific embodiments. It is appreciated that the specific embodiments described herein are only used for explaining the present disclosure, but not limiting the present invention. Also, for the convenience of description, the accompanying drawings illustrate only the relevant parts of the present invention not all contents thereof.

With the increasing demands for a higher resolution of a display device, the number of wired data lines and difficulties in wiring the data lines are increased accordingly. The increase of wired data lines results in a larger width of a frame for the AMOLED display panel employed in a display device, thus not meeting the current trend of a narrow frame. Further, the increase of the wired data lines increases the difficulties in a production process of the AMOLED display panel, and reduces the yield rate of AMOLED display panels.

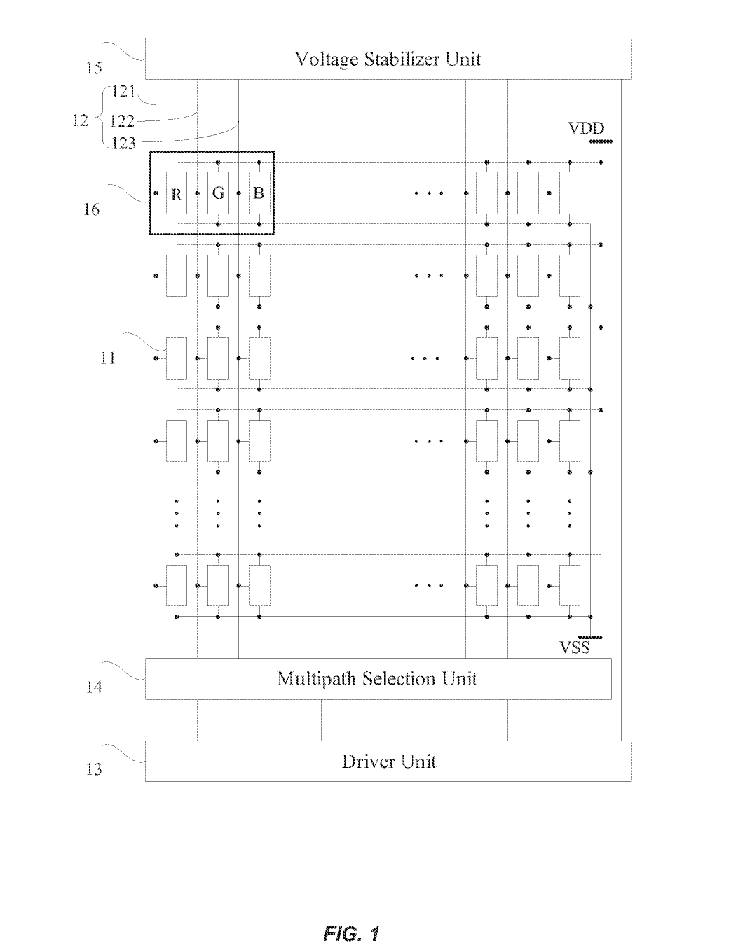

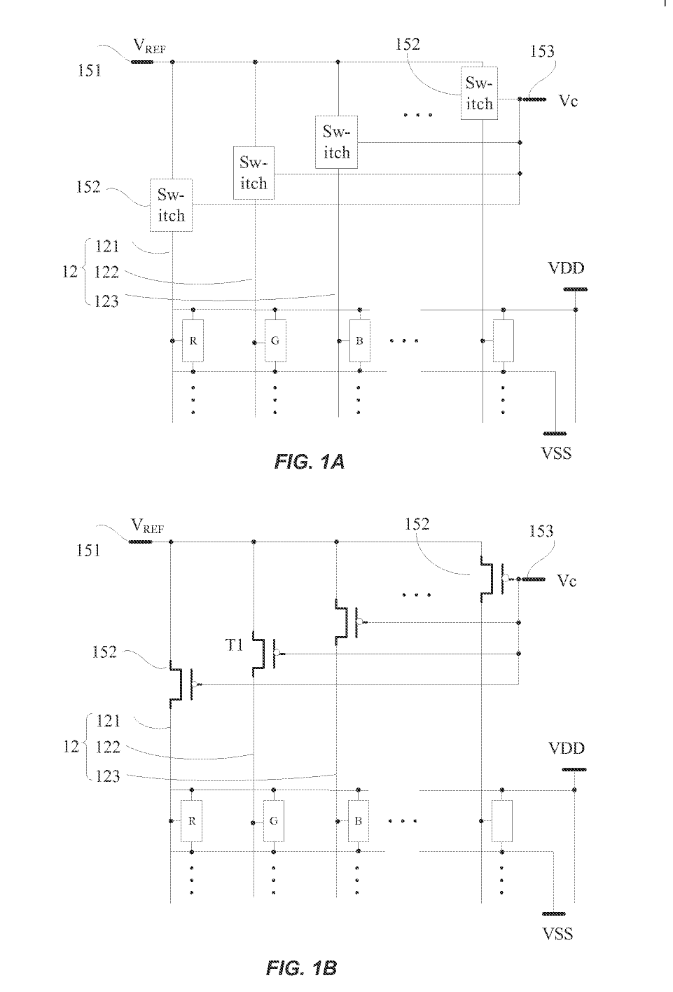

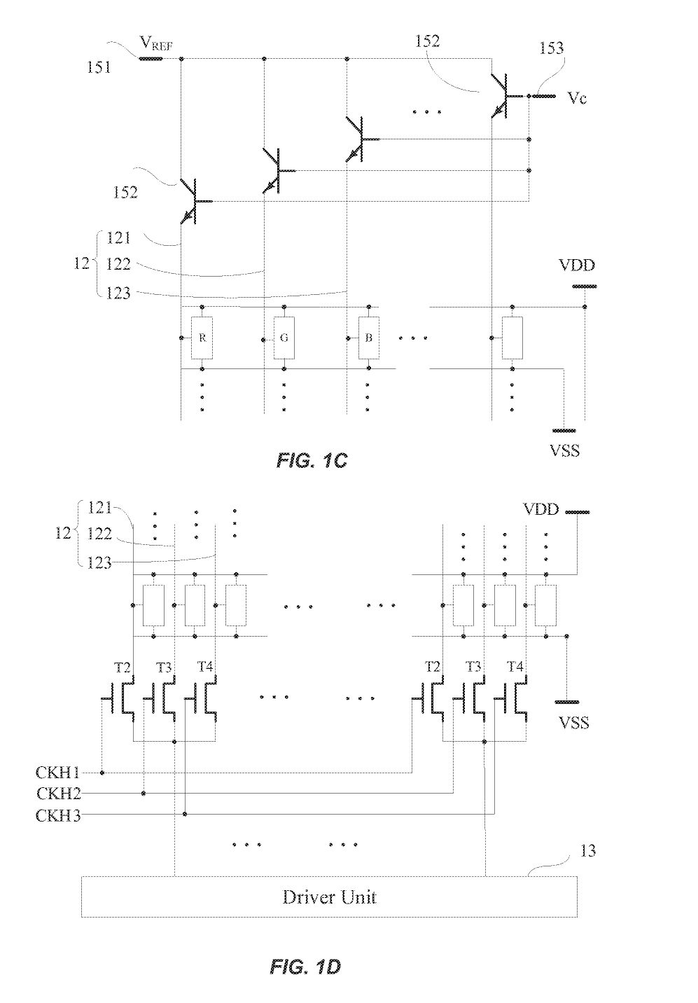

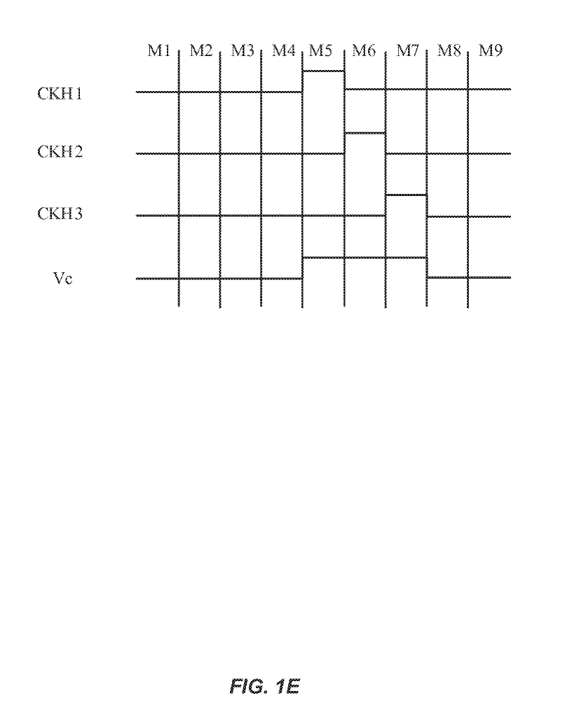

FIG. 1 is a schematic diagram showing the structure of an AMOLED display panel according to an embodiment of the present invention. Referring to FIG. 1, the AMOLED display panel includes: a multitude of pixel circuits 11; a multitude of data lines 12 coupled to the pixel circuits 11; a driver unit 13, which is configured to provide a first data signal; a multipath selection unit 14, which is connected between the data lines 12 and the driver unit 13 and configured to transmit the first data signal to the selected data line 12; and a voltage stabilizer unit 15, which is connected to the data lines 12 and configured to output a second data signal to the data lines 12, whereby, before a data writing stage, the second data signal outputted from the voltage stabilizer unit 15 is applied to the data lines 12.

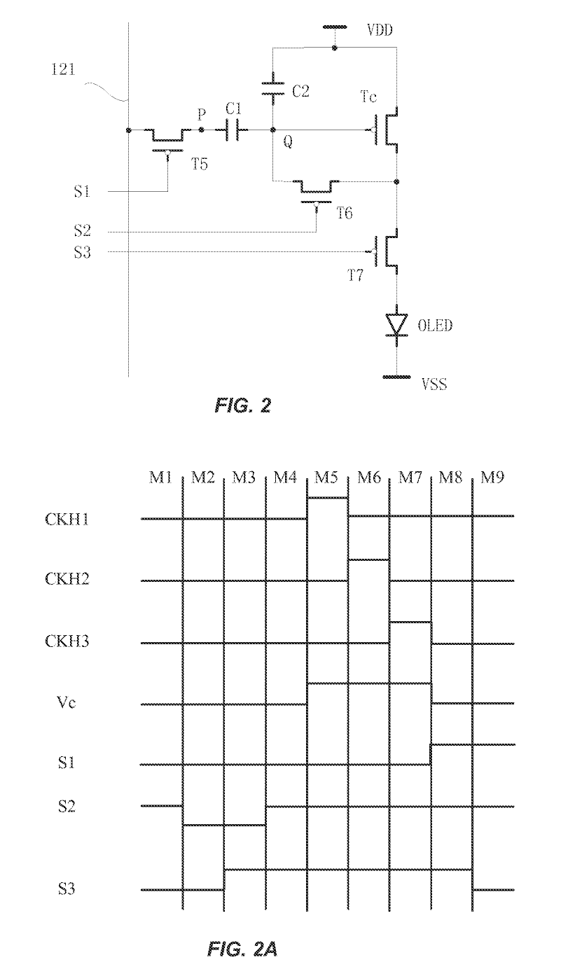

Specifically, referring to FIG. 1, FIG. 1A, and FIG. 2, the pixel circuits 11 include basic driving circuits for each pixel unit 16 in the AMOLED display panel, and the number of the pixel circuits 11 reflects the resolution of the AMOLED display panel. In an embodiment, each pixel unit 16 includes a first sub-pixel circuit (e.g. a red (R) sub-pixel circuit), a second sub-pixel circuit (e.g. a green (G) sub-pixel circuit) and a third sub-pixel circuit (e.g. a blue (B) sub-pixel circuit).

FIG. 1A and FIG. 2 also show a power source VDD and a ground terminal VSS which are electrically connected to all the pixel circuits 11. The power source VDD applies a high level signal to the pixel circuits 11, and the ground terminal VSS applies a grounding low level signal to the pixel circuits 11.

Referring to FIG. 1, the data lines 12 include a first data line 121, a second data line 122 and a third data line 123. In an embodiment, the first data line 121 is connected to an R sub-pixel circuit, the second data line 122 is connected to a G sub-pixel circuit, and the third data line 123 is connected to a B sub-pixel circuit. In an embodiment, at an initialization stage, the driver unit 13 stops outputting the first data signal, and the second data signal outputted from the voltage stabilizer unit 15 is applied to the data lines 12; and at a data writing stage, the voltage stabilizer unit 15 stops outputting the second data signal, and the first data signal outputted from the driver unit 13 is applied to the data lines 12.

Furthermore, FIG. 1A is a schematic diagram showing the structure of the voltage stabilizer unit of the AMOLED display panel in an embodiment of the present invention. Referring to FIG. 1 and FIG. 1A, the voltage stabilizer unit of the AMOLED display panel in an embodiment includes a reference voltage line 151, and the driver unit 13 is configured to provide a reference potential V_{REF} to the reference voltage line 151. In other embodiment, the reference potential V_{REF} applied to the reference voltage line 151 may be provided by another driving unit (not shown), and the embodiments of the present invention are not limited thereto.

Furthermore, the voltage stabilizer unit also includes: a plurality of switches 152, which are electrically connected to the reference voltage line 151 and the data lines 12; and a control line 153, which is electrically connected to the plurality of switches 152 and configured to control a switching state of the switches 152. Here, before the data writing stage, the switches 152 are turned on under the control of the control line 153, and the second data signal outputted from the reference voltage line 151 is applied to the data lines 12. Typically, the switches 152 may be embodied by components having a switching feature, such as field effect transistors (e.g. metal oxide semiconductors field effect transistors (MOSFETs)), Bipolar Junction Transistors (BJTs), or alternatively be embodied by circuits having a switching feature that are formed by electronic components such as transistors or logic gates. In an embodiment, as shown in FIG. 1B, switches 152 are embodied by first switching transistors T1, where gate electrodes of the first switching transistors T1 are electrically connected to the control line 153, source electrodes or drain electrodes are electrically connected to the reference voltage line 151, and drain electrodes or source electrodes are electrically connected to the data lines 12. Specifically, in the present embodiment, the data lines 12 include the first data line 121 connected to the R sub-pixel circuit, the second data line 122 connected to the G sub-pixel circuit, and the third data line 123 connected to the B sub-pixel circuit. The first switching transistors T1 are connected to the first data line 121, the second data line 122 and the third data line 123, respectively.

FIG. 1B is a schematic diagram showing the case where MOS transistors are used as the switches of the voltage stabilizer unit in an embodiment of the present invention. Referring to FIG. 1B, in the present embodiment, the switches 152 are embodied by field effect transistors (e.g. FETs), i.e. the first switching transistors T1; and the control line 153 is electrically connected to the plurality of switches 152 to apply a control signal Vc to each of the switches 152, for controlling the switching states of the switches 152. In the present embodiment, before the data writing stage, the control signal Vc provided by the control line 153 enables the switches 152 to turn on, so that the second data signal outputted from the reference voltage line 151 is applied to the data lines 12, that is, the first data line 121, the second data line 122 and the third data line 123 respectively receives the second data signal outputted from the reference voltage line 151 via the turned-on first switching transistors T1.

Alternatively, in an embodiment, the first switching transistors T1 are embodied by PMOS transistors. In other embodiments, the first switching transistors T1 may also be embodied by NMOS transistors for those skilled in the art.

Specifically, in the present embodiment, the control line 153 outputs a control signal Vc, which is a pulse signal. If the first switching transistors T1 are embodied as NMOS transistors and the pulse signal is at a high level, the first switching transistors T1 are turned on; whereas, if the first switching transistors T1 are embodied as PMOS transistors and the pulse signal is at a low level, the first switching transistors T1 are turned on.

FIG. 1C is a schematic structural diagram showing another embodiment of the switches of the voltage stabilizer unit. Referring to FIG. 1C, in the present embodiment, the switches of the voltage stabilizer unit are embodied as NPN-type BJTs. Those skilled in the art would appreciate that the switches can also be embodied as PNP-type BJTs in other embodiments.

FIG. 1D is a schematic diagram showing the structure of a multipath selection unit of the AMOLED display panel according to an embodiment of the present invention. Referring to FIG. 1D, in the present embodiment, the multipath selection unit includes: a second switching transistor T2, a third switching transistor T3, and a fourth switching transistor T4. The data lines 12 include the first data line 121, the second data line 122 and the third data line 123.

Referring to FIG. 1D, in the present embodiment, the drain electrode of the second switching transistor T2 is electrically connected to the first data line 121, and the gate electrode of the second switching transistor T2 is electrically connected to a first selection line CKH1; the drain electrode of the third switching transistor T3 is electrically connected to the second data line 122, and the gate electrode of the third switching transistor T3 is electrically connected to a second selection line CKH2; the drain electrode of the fourth switching transistor T4 is electrically connected to the third data line 123, and the gate electrode of the fourth switching transistor T4 is electrically connected to a third selection line CKH3; and the source electrode of the second switching transistor T2, the source electrode of the third switching transistor T3 and the source electrode of the fourth switching transistor T4 are connected together to the driver unit 13, to receive the first data signal from the driver unit 13. In the present embodiment, the first data line 121 is connected to the first sub-pixel circuit, the second data line 122 is connected to the second sub-pixel circuit and the third data line 123 is connected to the third sub-pixel circuit.

Alternatively, in the present embodiment, the second switching transistor T2, the third switching transistor T3 and the fourth switching transistor T4 are embodied by NMOS transistors. Those skilled in the art should understand that the second switching transistor T2, the third switching transistor T3 and the fourth switching transistor T4 may also be embodied by PMOS transistors in other embodiments. It should be noted that, in other embodiments, the multipath selection unit can be embodied by a component having a switching feature, such as a BJT, or alternatively be embodied by a circuit having a switching feature that is formed by electronic components such as transistors or logic gates. The types of the first switching transistor, second switching transistor, third switching transistor, and fourth switching transistor are not limited in the present embodiment.

Furthermore, the driver unit 13 is configured to provide the first data signal to the data lines 12. Specifically, FIG. 1e is a timing diagram of a control signal and a selection signal of the AMOLED display panel in an embodiment of the present invention. Referring to FIG. 1E, the present embodiment is described by an example in which a display unit (i.e. pixel unit) 16 is formed by the first sub-pixel circuit, the second sub-pixel circuit and the third sub-pixel circuit, and the workflow of the AMOLED display panel generally includes an initialization stage, a data writing stage, and a light emitting stage, which are described below.

In the initialization stage, referring to periods M1 to M4 in FIG. 1, FIG. 1B and FIG. 1D, the first selection line CKH1, the second selection line CKH2 and the third selection line CKH3 respectively controls the second switching transistor T2, the third switching transistor T3 and the fourth switching transistor T4 to be turned off, and the driver unit 13 stops outputting the first data signal, so that the first data signal is not applied to the first data line 121, the second data line 122 and the third data line 123. That is, the first data signal is not applied to any of the first sub-pixel circuit connected to the first data line 121, the second sub-pixel circuit connected to the second data line 122, and the third sub-pixel circuit connected to the third data line 123. Meanwhile, in the initialization stage, the control signal Vc provided by the control line 153 of the voltage stabilizer unit 15 turns on the first switching transistors T1, so that the data lines 12 receives the second data signal outputted from the reference voltage line 151 via the turned-on first switching transistors T1, that is, the second data signal is applied to each of the first data line 121, the second data line 122 and the third data line 123, and the data lines 12 transmit the second data signal to the pixel circuits 11, that is, the first data line 121, the second data line 122 and the third data line 123 transmit the second data signal to the first sub-pixel circuit, the second sub-pixel circuit and the third sub-pixel circuit, respectively.

The data writing stage includes a first stage, a second stage and a third stage.

In the first stage, referring to FIG. 1, FIG. 1B, FIG. 1D, and the period M5 in FIG. 1E, the first selection line CKH1 turns on the second switching transistor T2, the second selection line CKH2 turns off the third switching transistor T3, and the third selection line CKH3 turns off the fourth switching transistor T4, so that the first data line 121 receives the first data signal outputted from the driver unit 13, but both the second data line 122 and the third data line 123 do not receive the first data signal. At this stage, the first data signal is applied to the first data line 121 through the multipath selection unit 14, then the first data line 121 transmits the first data signal to the first sub-pixel circuit connected to the first data line 121, that is, the first data line 121 applies the first data signal outputted from the driver unit 13 to the first sub-pixel circuit. Meanwhile, the control signal Vc turns off the first switching transistors T1 at the first stage, to prevent the voltage stabilizer unit 15 from outputting the second data signal to the data lines 12.

In the second stage, referring to FIG. 1, FIG. 1B, FIG. 1D and the period M6 in FIG. 1E, the second selection line CKH2 provides a high level signal, while both the first selection line CKH1 and the third selection line CKH3 provide low level signals, that is, the second selection line CKH2 turns on the third switching transistor T3, while the first selection line CKH1 turns off the second switching transistor T2 and the third selection line CKH3 turns off the fourth switching transistor T4, so that the second data line 122 receives the first data signal outputted from the driver unit 13, and the first data line 121 and the third data line 123 do not receive the first data signal. At the second stage, the driver unit 13 provides the first data signal, and the first data signal is applied to the second data line 122 through the multipath selection unit 14, then the second data line 122 transmits the first data signal to the second sub-pixel circuit connected to the second data line 122. Meanwhile, the control signal Vc turns off the first switching transistors T1 in the second stage, to prevent the voltage stabilizer unit 15 from outputting the second data signal to the data lines 12.

In the third stage, referring to FIG. 1, FIG. 1B, FIG. 1D and the period M7 in FIG. 1E, the third selection line CKH3 turns on the fourth switching transistor T4, while the first selection line CKH1 turns off the second switching transistor T2 and the second selection line CKH2 turns off the third switching transistor T3, so that the third data line 123 receives the first data signal outputted from the driver unit 13, but both the first data line 121 and the second data line 122 do not receive the first data signal. At this stage, the driver unit 13 provides the first data signal, and the first data signal is applied to the third data line 123 through the multipath selection unit 14, then the third data line 123 transmits the first data signal to the third sub-pixel circuit connected to the third data line 123. Meanwhile, the control signal Vc turns off the first switching transistors T1 at this stage, to prevent the voltage stabilizer unit from outputting the second data signal to the data lines 12.

In the light emitting stage, referring to FIG. 1, FIG. 1B, FIG. 1D and the periods M8 to M9 in FIG. 1E, the first selection line CKH1 turns off control the second switching transistor T2, the second selection line CKH2 turns off the third switching transistor T3, and the third selection line CKH3 turns off the fourth switching transistor T4, the driver unit 13 does not provide the first data signal, and none of the first data line 121, the second data line 122 and the third data line 123 receives the first data signal. At this stage, a driving transistor generates a driving current to drive the light emitting diode to emit light for displaying an image.

In the present embodiment, the driver unit 13 does not provide the first data signal and the data lines 12 receive the second data signal outputted from the voltage stabilizer unit 15 in the initialization stage. In the data writing stage, the voltage stabilizer unit 15 does not provide the second data signal and the data lines 12 receive the first data signal outputted from the driver unit 13. In the light emitting stage, the driver unit 13 does not provide the first data signal, namely, neither the first data signal nor the second data signal is applied to the data lines 12.

Alternatively, in the present embodiment, the first data signal is a pulse signal, and the level of the second data signal is constant.

Alternatively, in the present embodiment, the level of the first data signal at the data writing stage is lower than the level of the first data signal at the initialization stage. A voltage difference between the high level and the low level of the first data signal is greater than or equal to 3V. The low level of the first data signal is in a range from 0V to 5V. A voltage difference between the level of the second data signal and the low level of the first data signal is greater than or equal to 3V.

In the AMOLED display panel provided by the present embodiment, due to the connecting of the voltage stabilizer unit and the data lines, a high level signal is applied to the data lines before the data writing stage. And with the voltage stabilizer unit disposed in the AMOLED display panel provided by the present embodiment, it is allowed to arrange the multipath selection unit between the driver unit and the data lines. As such, in the wiring of the AMOLED display panel, the use of the multipath selection unit allows that only one data line is needed for providing data signals to the first sub-pixel circuit, the second sub-pixel circuit and the third sub-pixel circuit for the purpose of image displaying, thereby reducing the number of data lines wiring (routing) in the frame (border) region for the AMOLED display panel. And due to the reduction of number of data lines wiring in the AMOLED display panel, the difficulty of manufacturing the AMOLED display panel is reduced, the frame for the AMOLED display panel is narrowed, and hence the volume of the AMOLED display panel is reduced.

With reference to the description of the above-described embodiment, another embodiment is further described below with reference to the specific structure of a pixel circuit in the AMOLED display panel, and meanwhile the AMOLED display panel also includes the voltage stabilizer unit, the driver unit, the multipath selection unit and so on as described in the above-mentioned embodiment.

FIG. 2 is a schematic diagram showing the structure of a pixel circuit in the AMOLED display panel according to another embodiment of the present invention. The present embodiment is described with an example in which the circuit of a pixel unit (i.e. display unit) in the AMOLED display panel is formed by a first sub-pixel circuit, a second sub-pixel circuit and a third sub-pixel circuit. Because the first sub-pixel circuit, the second sub-pixel circuit and the third sub-pixel circuit have the same circuit structure, only one sub-pixel circuit is illustratively shown in FIG. 2 for the purpose of description. For example, the first sub-pixel circuit is used as an R sub-pixel circuit, the second sub-pixel circuit is used as a G sub-pixel circuit and the third sub-pixel circuit is used as a B sub-pixel circuit, where the R sub-pixel circuit is coupled to the first data line(s), the G sub-pixel circuit is coupled to the second data line(s), and the B sub-pixel circuit is coupled to the third data line(s). Because the R sub-pixel circuit, the G sub-pixel circuit and the B sub-pixel circuit in the pixel circuit have the same circuit structure and are subjected to the same charge transfer in a timing cycle, one sub-pixel circuit is used in the following description.

Referring to FIG. 2, the R sub-pixel circuit (i.e. first sub-pixel circuit) is used as follows. The first sub-pixel circuit includes: a driving transistor Tc, an OLED, a fifth switching transistor T5, a sixth switching transistor T6, and a seventh switching transistor T7.

Specifically, in the present embodiment, a gate electrode of the driving transistor Tc is connected to a power source VDD via a second capacitor C2, and a source electrode of the driving transistor Tc is connected to the power source VDD.

A source electrode of the fifth switching transistor T5 is connected to the first data line 121, a drain electrode of the fifth switching transistor T5 is connected to the gate electrode of the driving transistor TC via a first capacitor C1, and a gate electrode of the fifth switching transistor T5 is configured to receive a first scan signal S1.

A drain electrode of the sixth switching transistor T6 is connected to the drain electrode of the driving transistor Tc, a source electrode of the sixth switching transistor T6 is connected to the gate electrode of the driving transistor Tc, and the gate electrode of the sixth switching transistor T6 is configured to receive a second scan signal S2.

A drain electrode of the seventh switching transistor T7 is connected to the ground terminal via the OLED, and a source electrode of the seventh switching transistor T7 is connected to the drain electrode of the driving transistor Tc.

In the present embodiment, the fifth switching transistor T5, the sixth switching transistor T6 and the driving transistor Tc each are PMOS transistors.

Furthermore, the seventh switching transistor T7 is a PMOS transistor, and the gate electrode of the seventh switching transistor T7 is configured to receive a third scan signal S3.

Furthermore, in the present embodiment, the first scan signal S1, the second scan signal S2 and the third scan signal S3 are independent of each other in timing.

FIG. 2A is a schematic driving timing diagram of a pixel circuit in another embodiment of the present invention. Referring to FIGS. 2A and 2, the driving timing in the present embodiment generally includes an initialization stage, a data writing stage and a light emitting stage as described below.

For the first sub-pixel circuit (i.e. R sub-pixel circuit), in the initialization stage, the control line turns on the first switching transistors T1, so that the second data signal outputted from the voltage stabilizer unit is applied to the first data line(s) 121. Specifically, the first scan signal S1 turns on the fifth switching transistor T5, the second scan signal S2 turns off the sixth switching transistor T6, and the third scan signal S3 turns off the seventh switching transistor T7. Thus, the first data line 121 charges the first capacitor C1 via the turned-on fifth switching transistor T5, so that a high level signal (i.e. the second data signal, which is in a constant high level) is applied to the corresponding data lines in the initialization stage. Herein, the voltage of the first data signal is denoted by Vdata, and the voltage of the second data signal is denoted by VS. Similarly, for the second sub-pixel circuit (i.e. G sub-pixel circuit), in the initialization stage, the second data line 122 charges the first capacitor C1 via the turned-on fifth switching transistor T5, so that a high level signal (i.e. the second data signal, which is in a constant high level) is applied to the corresponding data lines in the initialization stage, and for the third sub-pixel circuit (i.e. B sub-pixel circuit), in the initialization stage, the third data line 123 charges the first capacitor C1 via the turned-on fifth switching transistor T5, so that a high level signal (i.e. the second data signal, which is in a constant high level) is applied to the corresponding data lines in the initialization stage.

In other words, the voltage stabilizer unit provides the second data signal to the data lines in the initialization stage, specifically, in the initialization stage, the second data signal is applied to the first data line(s) of the first sub-pixel circuit (i.e. R sub-pixel circuit), the second data signal is applied to the second data line(s) of the second sub-pixel circuit (i.e. G sub-pixel circuit) and the second data signal is applied to the third data line(s) of the third sub-pixel circuit (i.e. B sub-pixel circuit), respectively.

Referring to FIG. 2A, in the present embodiment, the initialization stage may include periods M1-M3 described below. In the period M1, the first scan signal S1 and the third scan signal S3 are at a low level, and the second scan signal S2 is at a high level, so that the fifth switching transistor T5 and the seventh switching transistor T7 are turned on, while the sixth switching transistor T6 is turned off.

At the period M2, the second scan signal S2 is at a low level, and the first scan signal S1 and the third scan signal S3 are at a low level, so that the sixth switching transistor T6 is turned on, and the seventh switching transistor T7 is still turned on in period M2; therefore, the level of the gate electrode of the driving transistor Tc is pulled down to a low level to turn on the driving transistor Tc by the turned-on sixth switching transistor T6, the turned-on seventh switching transistor T7 and the ground terminal VSS, namely, the voltage at a node Q is pulled down to a low level to turn on the driving transistor Tc.

At the period M3, the third scan signal S3 is at a high level, and the first scan signal S1 and the second scan signal S2 are at a low level, so that the seventh switching transistor T7 is turned off, and the fifth switching transistor T5 and the sixth switching transistor T6 are turned on; in this case, the voltage of the power source VDD is applied to the node Q via the turned-on driving transistor Tc and the turned-on sixth switching transistor T6, so the potential value at the node Q is pulled up to VDD-Vth, wherein, the VDD is determined as the voltage of the power source VDD, and Vth is determined as the threshold voltage of the driving transistor Tc, VDD-Vth is determined by the voltage of the power source minus the threshold voltage of the driving transistor Tc.

At the period M4, the second scan signal S2 is at a high level, the first scan signal S1 is at a low level and the third scan signal S3 is at a high level, so that the sixth switching transistor T6 is turned off, the fifth switching transistor T5 and the seventh switching transistor T7 is turned on, the voltage at the node P is pulled up to the voltage VS of the second data signal, and the voltage at the node Q is maintained at VDD-Vth, which is the voltage of the power source minus the threshold voltage of the driving transistor Tc.

In the data writing stage, the driver unit provides the first data signal to the corresponding data lines, and specifically the data writing stage includes a fourth stage, a fifth stage, and a sixth stage.

At the fourth stage, the first scan signal S1 turns on the fifth switching transistor T5, and the second scan signal S2 and the third scan signal S3 respectively turn off the sixth switching transistor T6 and the seventh switching transistor T7. In general, at the fourth stage, the first data signal outputted from the driver unit is applied to the first data line 121, but not to the second data line 122 and the third data line 123, namely, at the fourth stage, the first data signal is applied to the R sub-pixel circuit, but the first data signal is not applied to G sub-pixel circuit and B sub-pixel circuit.

Specifically, referring to the period M5 in FIG. 2A, in period M5 (at the fourth stage), in view of R sub-pixel circuit, the first scan signal S1 is at a low level, and the second scan signal S2 and the third scan signal S3 are at a high level, so that the fifth switching transistor T5 is turned on, and the sixth switching transistor T6 and the seventh switching transistor T7 are turned off; meanwhile, the first selection line CKH1 is at a high level, the second selection line CKH2 and the third selection line CKH3 are at a low level, so that the second switching transistor T2 is turned on, then the first data signal outputted from the drive unit is applied to the first data line 121 of the R sub-pixel circuit through the turned-on second switching transistor T2 and the first data line 121, then the voltage Vdata of the first data signal is transmitted to the node P, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor Tc. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

At the fifth stage, the first scan signal S1 controls the fifth switching transistor T5 to turn on, and the second scan signal S2 and the third scan signal S3 respectively control the sixth switching transistor T6 and the seventh switching transistor T7 to turn off. In general, at the fifth stage, the first data signal outputted from the driver unit is applied to the second data line 122, but not to the first line 121 and the third data line 123, namely, at the fifth stage, the first data signal is applied to the G sub-pixel circuit, but the first data signal is not applied to R sub-pixel circuit and B sub-pixel circuit.

Specifically, referring to the period M6 in FIG. 2A, in period M6 (at the fifth stage), in view of G sub-pixel circuit, the first scan signal S1 is at a low level, and the second scan signal S2 and the third scan signal S3 are at a high level, so that the fifth switching transistor T5 is turned on, and the sixth switching transistor T6 and the seventh switching transistor T7 are turned off; meanwhile, the second selection line CKH2 is at a high level, the first selection line CKH1 and the third selection line CKH3 are at a low level, so that the third switching transistor T3 is turned on, and the first data signal outputted from the drive unit is applied to the second data line 122 of the G sub-pixel circuit through the turned-on third switching transistor T3 and the second data line 122, then the voltage Vdata of the first data signal is applied to the node P, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

At the sixth stage, the first scan signal controls the fifth switching transistor T5 to turn on, the second scan signal and the third scan signal respectively control the sixth switching transistor T6 and the seventh switching transistor T7 to turn off. In general, at the sixth stage, the first data signal outputted from the driver unit is applied to the third data line 123, but not to the first line 121 and the second data line 122, namely, at the sixth stage, the first data signal is applied to the B sub-pixel circuit, but the first data signal is not applied to R sub-pixel circuit and G sub-pixel circuit.

Specifically, referring to the period M7 in FIG. 2A, in period M7 (at the sixth stage), in view of B sub-pixel circuit, the first scan signal S1 is at a low level, and the second scan signal S2 and the third scan signal S3 are at a high level, so that the fifth switching transistor T5 is turned on, and the sixth switching transistor T6 and the seventh switching transistor T7 are turned off; meanwhile, the third selection line CKH3 is at a high level, the first selection line CKH1 and the second selection line CKH2 are at a low level, so that the fourth switching transistor T4 is turned on, and the first data signal outputted from the drive unit is applied to the third data line 123 of the B sub-pixel circuit through the turned-on fourth switching transistor T4, then the voltage Vdata of the first data signal is applied to the node P through the turned-on fifth switching transistor T5, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

At the light emitting stage (i.e. illuminating stage), the driving transistor generates a driving current to enable the illuminating of organic light emitting diodes (OLEDs). Referring to periods M8 and M9 in FIG. 2A, the first scan signal S1 and the second scan signal S2 respectively control the fifth switching transistor T5 and the sixth switching transistor T6 to turn off, the third scan signal S3 controls the seventh switching transistor T7 to turn on, and the driving transistor Tc generates the driving current to enable the illuminating of OLEDs.

Specifically, after the turning on of the seventh switching transistor T7, the voltage of the power source VDD is applied to the driving transistor Tc, the voltage at the gate electrode of the driving transistor Tc is VDD-Vth+Vdata-VS, and the driving current I generated by the driving transistor Tc is I=K(VS-Vdata)² considering that I=K(Vsg-Vth)², wherein, Vsg is determined by the voltage of the source electrode of the driving transistor Tc minus the voltage of the gate electrode of the driving transistor Tc, where, K is a driver coefficient which depends on characteristic parameters of the driving transistor Tc.

In the AMOLED display panel provided by the present embodiment, due to the voltage stabilizer unit connected to the data lines, a high level signal is applied to the data lines before the data writing stage. And by the use of the voltage stabilizer unit for the AMOLED display panel provided by the present embodiment, it is allowed to arrange the multipath selection unit between the driver unit and the data lines. As such, for the wiring of the AMOLED display panel, the use of the multipath selection unit allows that, only one data line in the frame area of display panel is needed for one pixel unit (i.e. display unit), and namely, considering that one pixel unit includes a first sub-pixel circuit, a second sub-pixel circuit and a third sub-pixel circuit, therefore, only one data line in the frame area of display panel is needed for transmitting data signals to a first sub-pixel circuit, a second sub-pixel circuit and a third sub-pixel circuit, for the purpose of image displaying, and furthermore reducing the number of data line routings in the frame region for the AMOLED display panel. Moreover, due to the reduction of the data lines routings in the AMOLED display panel, the difficulty of manufacturing the AMOLED display panel is reduced, the frame for the AMOLED display panel is narrowed, and hence the volume of the AMOLED display panel is reduced.

With reference to the t embodiments mentioned above, another embodiment is provided further. In the present embodiment, the technical solution of the present disclosure is described in combination with a specific implementation of a pixel unit, meanwhile in the present embodiment, the AMOLED display panel also includes the voltage stabilizer unit, the driver unit, the multipath selection unit and so on in the above-mentioned embodiment.

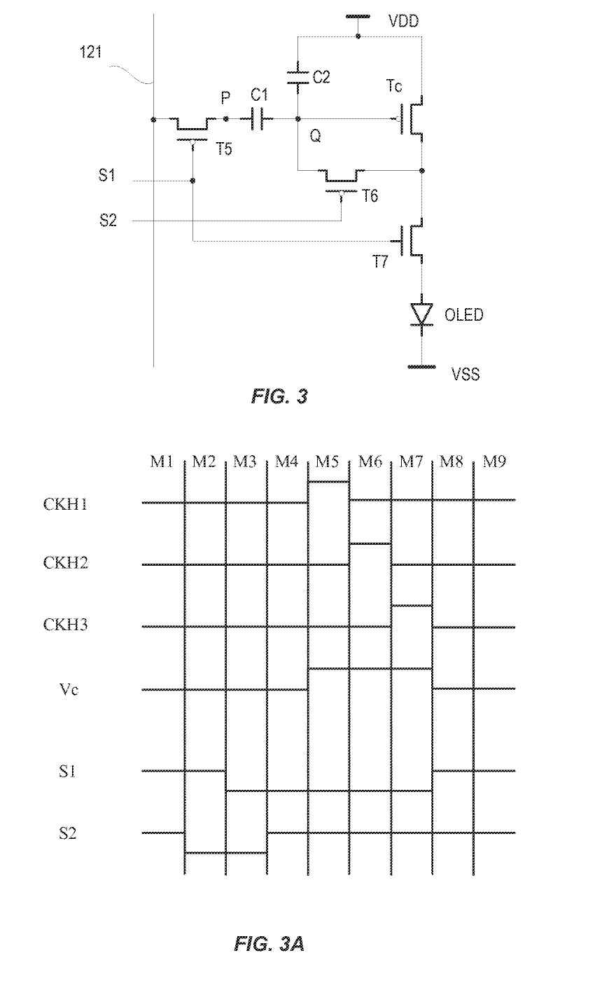

FIG. 3 is a schematic diagram showing the structure of a pixel unit of the AMOLED display panel in another embodiment of the present invention. The present embodiment is described with an example in which the pixel unit includes a first sub-pixel circuit, a second sub-pixel circuit and a third sub-pixel circuit in the AMOLED display panel. Because the first sub-pixel circuit, the second sub-pixel circuit and the third sub-pixel circuit have the same circuit structure, only one sub-pixel circuit is illustratively described, For example, the first sub-pixel circuit is exampled as an R sub-pixel circuit, the second sub-pixel circuit is exampled as a G sub-pixel circuit and the third sub-pixel circuit is exampled as a B sub-pixel circuit, where the R sub-pixel circuit is coupled to the first data line(s), the G sub-pixel circuit is coupled to the second data line(s), and the B sub-pixel circuit is coupled to the third data line(s). Because the R sub-pixel circuit, the G sub-pixel circuit and the B sub-pixel circuit in the pixel circuit have the same circuit structure and are subjected to the same charge transfer in a timing cycle, one sub-pixel circuit is exampled in the following description, i.e. the first sub-pixel circuit is exampled as follows, and the present invention is not limited thereto.

Referring to FIG. 3, the R sub-pixel circuit (i.e., first sub-pixel circuit) is used as an example for the first sub-pixel circuit, in which a seventh switching transistor T7 is an NMOS transistor, and a gate electrode of the seventh switching transistor T7 is connected to the gate electrode of the fourth switching transistor T4, to receive the first scan signal S1.

Furthermore, the first scan signal S1 and the second scan signal S2 are independent of each other in timing.

FIG. 3A is a schematic driving timing diagram of the pixel circuit driver in the present embodiment. Referring to FIG. 3A, FIG. 3 and FIG. 1B, the driving timing generally includes an initialization stage, a data writing stage and a light emitting stage in the present embodiment.

For the first sub-pixel circuit (R sub-pixel circuit), in the initialization stage, the control line 153 turns on the first switching transistors T1, so that the second data signal outputted from the voltage stabilizer unit is applied to the first data line(s) 121; specifically, the first scan signal S1 turns on the fifth switching transistor T5 to turn on and turns off the seventh switching transistor T7, the second scan signal S2 turns off the sixth switching transistor T6, and the first data line 121 charges the first capacitor C1 via the turned-on fifth switching transistor T5, so that a high level signal (i.e. the second data signal, which is in a constant high level) is applied to the corresponding data lines in the initialization stage. Herein, the voltage of the first data signal is denoted by Vdata, and the voltage of the second data signal is denoted by VS. Similarly, for the second sub-pixel circuit (i.e. G sub-pixel circuit), in the initialization stage, the second data line 122 charges the first capacitor C1 via the turned-on fifth switching transistor T5, so that a high level signal (i.e. the second data signal, which is in a constant high level) is applied to the corresponding data lines in the initialization stage, and for the third sub-pixel circuit (B sub-pixel circuit), in the initialization stage, the third data line 123 charges the first capacitor C1 via the turned-on fifth switching transistor T5, so that a high level signal (i.e. the second data signal, which is in a constant high level) is applied to the corresponding data lines in the initialization stage.

Generally, in the present embodiment, the voltage stabilizer unit provides a second data signal to the corresponding data lines in the initialization stage.

Referring to the timing diagram of FIG. 3A, in the present embodiment, the initialization stage includes periods M1, M2, M3 and M4.

In the period M1, the first scan signal S1 and the second scan signal S2 are at a high level, so that the seventh switching transistor T7 is turned on, and the fifth switching transistor T5 and the sixth switching transistor T6 are turned off.

In the period M2, the first scan signal S1 is at a high level, and the second scan signal S2 is at a low level, so that the fifth switching transistor T5 is turned off, and the sixth switching transistor T6 and the seventh switching transistor T7 are turned on, therefore, the level of the gate electrode of the driving transistor Tc is pulled down to a low level to turn on the driving transistor Tc by the turned-on sixth switching transistor T6, the turned-on seventh switching transistor T7 and the ground terminal VSS, namely, the voltage at a node Q is pulled down to a low level to turn on the driving transistor Tc.

In the period M3, the first scan signal S1 and the second scan signal S2 are at a low level, so that the seventh switching transistor T7 is turned off, and the fifth switching transistor T5 and the sixth switching transistor T6 are turned on, then the voltage of the power source VDD is applied to the node Q via the turned-on driving transistor Tc and the turned-on sixth switching transistor T6, so the potential value at the node Q is pulled up to VDD-Vth, wherein, the VDD is determined as the voltage of the power source VDD, and Vth is determined as the threshold voltage of the driving transistor Tc, VDD-Vth is determined by the voltage of the power source minus the threshold voltage of the driving transistor Tc.

In the period M4, the second scan signal S2 is at a high level, and the first scan signal S1 is at a low level, so that the sixth switching transistor T6 is turned off, the fifth switching transistor T5 and the seventh switching transistor T7 is turned on, the voltage at the node P is pulled up to the voltage VS of the second data signal, and the voltage at the node Q is maintained at VDD-Vth, which is the voltage of the power source minus the threshold voltage of the driving transistor Tc.

In the data writing stage, the driver unit provides the first data signal to the corresponding data lines. Specifically, the data writing stage includes a seventh period, an eighth period and a ninth period.

In the seventh stage, the first scan signal S1 turns on the fifth switching transistor T5 and turns off the seventh switching transistor T7, and the second scan signal S2 turns off the sixth switching transistor T6. In general, at the seventh stage, the first data signal outputted from the driver unit is applied to the first data line 121, but not to the second data line 122 and the third data line 123, namely, at the seventh stage, the first data signal is applied to the R sub-pixel circuit, but the first data signal is not applied to G sub-pixel circuit and B sub-pixel circuit.

Specifically, referring to the period M5 in FIG. 3A, in period M5 (at the seventh stage), in view of R sub-pixel circuit, the first scan signal S1 is at a low level and the second scan signal S2 is at a high level, so that the second switching transistor T2 is turned on, then the first data signal outputted from the drive unit is applied to the first data line 121 of the R sub-pixel circuit through the turned-on second switching transistor T2 and the first data line 121, then the voltage Vdata of the first data signal is transmitted to the node P, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor Tc. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

In the eighth stage, the first scan signal S1 turns on the fifth switching transistor T5 and turns off the seventh switching transistor T7, the second scan signal S2 turns off the sixth switching transistor T6. In general, at the eighth stage, the first data signal outputted from the driver unit is applied to the second data line 122, but not to the first line 121 and the third data line 123, namely, at the eighth stage, the first data signal is applied to the G sub-pixel circuit, but the first data signal is not applied to R sub-pixel circuit and B sub-pixel circuit.

Specifically, referring to the period M6 in FIG. 3A, in period M6 (at the eighth stage), in view of G sub-pixel circuit, the first scan signal S1 is at a low level, and the second scan signal S2 is at a high level, so that the fifth switching transistor T5 is turned on, and the sixth switching transistor T6 and the seventh switching transistor T7 are turned off; meanwhile, the second selection line CKH2 is at a high level, the first selection line CKH1 and the third selection line CKH3 are at a low level, so that the third switching transistor T3 is turned on, and the first data signal outputted from the drive unit is applied to the second data line 122 of the G sub-pixel circuit through the turned-on third switching transistor T3 and the second data line 122, then the voltage Vdata of the first data signal is applied to the node P, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

In the ninth stage, the first scan signal controls the fifth switching transistor T5 to turn on and controls the seventh switching transistor T7 to turn off, and the second scan signal controls the sixth switching transistor T6 to turn off. In general, at the ninth stage, the first data signal outputted from the driver unit is applied to the third data line 123, but not to the first line 121 and the second data line 122, namely, at the ninth stage, the first data signal is applied to the B sub-pixel circuit, but the first data signal is not applied to R sub-pixel circuit and G sub-pixel circuit.

Specifically, referring to the period M7 in FIG. 3A, in period M7 (at the ninth stage), in view of B sub-pixel circuit, the first scan signal S1 is at a low level, and the second scan signal S2 is at a high level, so that the fifth switching transistor T5 is turned on, and the sixth switching transistor T6 and the seventh switching transistor T7 are turned off; meanwhile, the third selection line CKH3 is at a high level, the first selection line CKH1 and the second selection line CKH2 are at a low level, so that the fourth switching transistor T4 is turned on, and the first data signal outputted from the drive unit is applied to the third data line 123 of the B sub-pixel circuit through the turned-on fourth switching transistor T4, then the voltage Vdata of the first data signal is applied to the node P through the turned-on fifth switching transistor T5, so the voltage at the node P is changed to Vdata (namely, the change of the voltage at the node P is VS-Vdata, VS-Vdata is determined by the voltage VS of the second data signal minus the voltage Vdata of the first data signal), and the voltage at the node Q is VDD-Vth, which is the voltage of the power source minus the threshold voltage of the driving transistor. As such, the voltage at the node Q and the voltage at the node P are coupled through the coupling effect of the first capacitor C1, resultantly, the voltage at the gate electrode of the driving transistor Tc is changed to VDD-Vth+Vdata-VS.

In the light emitting stage (i.e. illuminating stage), the driving transistor generates a driving current to enable the illuminating of organic light emitting diodes (OLEDs). The light emitting stage includes periods M8 and M9 in FIG. 3A.

The first scan signal S1 and the second scan signal S2 respectively control the fifth switching transistor T5 and the sixth switching transistor T6 to turn off, and control the seventh switching transistor T7 to turn on, and the driving transistor Tc generates the driving current to enable the illuminating of OLEDs. Specifically, after the turning on of the seventh switching transistor T7, the voltage of the power source VDD is applied to the driving transistor Tc, the voltage at the gate electrode of the driving transistor Tc is VDD-Vth+Vdata-VS, and the driving current I generated by the driving transistor Tc is I=K(VS-Vdata)² considering that I=K(Vsg-Vth)², wherein, Vsg is determined by the voltage of the source electrode of the driving transistor Tc minus the voltage of the gate electrode of the driving transistor Tc, where, K is a driver coefficient which depends on characteristic parameters of the driving transistor Tc

In the AMOLED display panel provided by the present embodiment, due to the voltage stabilizer unit connected to the data lines, a high level signal is applied to the data lines before the data writing stage. And by the use of the voltage stabilizer unit for the AMOLED display panel provided by the present embodiment, it is allowed to arrange the multipath selection unit between the driver unit and the data lines. As such, for the wiring of the AMOLED display panel, the use of the multipath selection unit allows that, only one data line in the frame area of display panel is needed for one pixel unit (display unit), and namely, considering that one pixel unit includes a first sub-pixel circuit, a second sub-pixel circuit and a third sub-pixel circuit, therefore, only one data line in the frame area of display panel is needed for transmitting data signals to a first sub-pixel circuit, a second sub-pixel circuit and a third sub-pixel circuit, for the purpose of image displaying, and furthermore reducing the number of data lines routings in the frame region for the AMOLED display panel. Moreover, due to the reduction of the data line routings in the AMOLED display panel, the difficulty of manufacturing the AMOLED display panel is reduced, the frame for the AMOLED display panel is narrowed, and hence the volume of the AMOLED display panel is reduced.

Furthermore, in the AMOLED display panel of the present embodiment, the gate electrode of the seventh switching transistor T7 and the gate electrode of the fifth switching transistor T5 are connected together to receive the first scan signal S1. Compared with the prior art, the connection between the gate electrode of the fifth switching transistor T5 and the gate electrode of the seventh switching transistor T7 further reduces the number of data line routings in the display panel, thus reducing the difficulty in wiring of the AMOLED display panel, reducing the volume of the AMOLED display panel, and narrowing the frame for the AMOLED display panel.

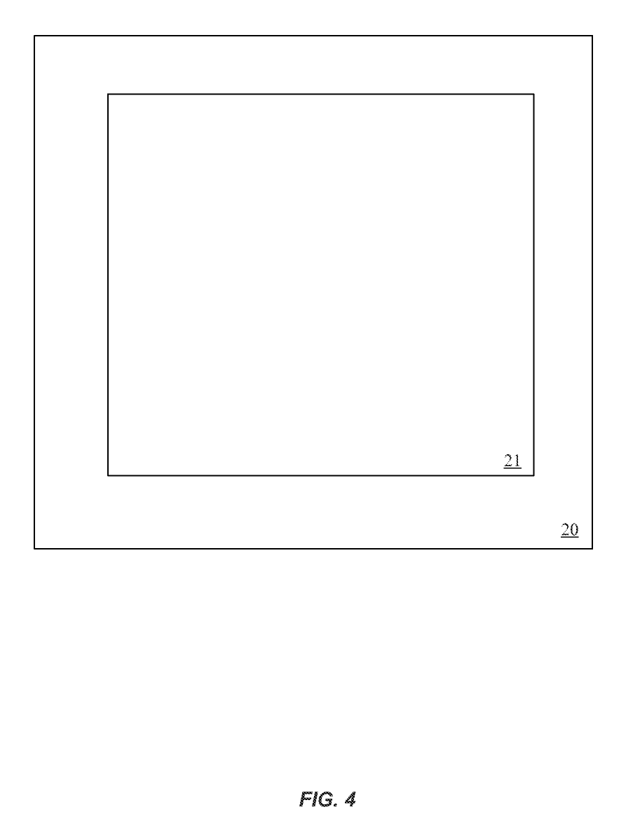

As shown in FIG. 4, another embodiment of the present invention also provides an organic light emitting diode display device 20, which includes an AMOLED display panel 21. The AMOLED display panel 21 may be any one embodiment or any one example of the AMOLED display panels described above.

The organic light emitting diode display device 20 of the present embodiment also includes a power supply unit (not shown) and other components known in the art, which will not be described herein for the sake of brevity.

As for the organic light emitting diode display device including the above AMOLED display panel provided by the present embodiment, due to the simplified manufacturing process of the AMOLED display panel and the reduction of the volume and weight of the AMOLED display panel, the organic light emitting diode display device provided by the embodiments of the present invention has the advantages of lower manufacturing costs, a smaller volume, and a lighter weight.

Specific embodiments of the present invention have been described above, but are not intended to limit the present invention. Those skilled in the art may make various alterations and variations to the present invention. All the alterations and variations made without departing from the spirit and principles of the present invention should fall within the protection scope of the prevent invention.

What is claimed is:

1. An AMOLED display panel, comprising:
a plurality of pixel circuits;
a plurality of data lines coupled to the pixel circuits;
a driver unit configured to provide a first data signal;
a multipath selection unit connected between the data lines and the driver unit and configured to transmit the first data signal to selected data line; and
a voltage stabilizer unit connected to the data lines and configured to output a second signal to the data lines;
wherein, before a data writing stage, the second signal outputted from the voltage stabilizer unit is applied to the data lines.

2. The AMOLED display panel of claim 1, wherein,
in an initialization stage, the second data signal outputted from the voltage stabilizer unit is applied to the data lines; and
in a data writing stage, the first data signal provided by the driver unit is applied to the data lines.

3. The AMOLED display panel of claim 2, wherein the voltage stabilizer unit comprises:
a reference voltage line;
a plurality of switches, each of the switches electrically connected to the reference voltage line and one of the data lines; and
a control line electrically connected to the plurality of switches and configured to control the switches;
wherein, before the data writing stage, the control line is configured to turn on the switches, and the second data signal outputted from the reference voltage line is applied to the data lines.

4. The AMOLED display panel of claim 3, wherein the switches are first switching transistors, each of the first switching transistors having a gate electrode connected to the control line, a source electrode or a drain electrode electrically connected to the reference voltage line, and a drain electrode or a source electrode electrically connected to one of the data lines, wherein the data lines comprise a first data line, a second data line, and a third data line.

5. The AMOLED display panel of claim 4, wherein the multipath selection unit comprises: a second switching transistor, a third switching transistor, and a fourth switching transistor; wherein:
a drain electrode of the second switching transistor is electrically connected to the first data line, and a gate electrode of the second switching transistor is electrically connected to a first selection line;
a drain electrode of the third switching transistor is electrically connected the second data line, and a gate electrode of the third switching transistor is electrically connected to a second selection line;
a drain electrode of the fourth switching transistor is electrically connected the third data line, and a gate electrode of the fourth switching transistor is electrically connected to a third selection line; and
a source electrode of the second switching transistor, a source electrode of the third switching transistor, and a source electrode of the fourth switching transistor are connected to the driver unit, so as to receive the first data signal outputted from the driver unit.

6. The AMOLED display panel of claim 5, wherein,
in the initialization stage, the first selection line, the second selection line and the third selection line respectively turn off the second switching transistor, the third switching transistor and the fourth switching transistor, and the driver unit stops outputting the first data signal;
the data writing stage comprises:
a first stage, in which the first selection line turns on the second switching transistor, and the second selection line and the third selection line respectively turn off the third switching transistor and the fourth switching transistor, the first data signal outputted from the driver unit is applied to the first data line, but not to the second data line and the third data line;
a second stage, in which the second selection line turns on the third switching transistor, and the first selection line and the third selection respectively turn off the second switching transistor and the fourth switching transistor, the first data signal outputted from the driver unit is applied to the second data line, but not to the first data line and the third data line; and
a third stage, in which the third selection line turns on the fourth switching transistor, and the first selection line and the second selection respectively turn off the second switching transistor and the third switching transistor, the first data signal outputted from the driver unit is applied to the third data line, but not to the first data line and the second data line;
wherein, in a light emitting stage, the first selection line, the second selection line and the third selection line respectively turn off the second switching transistor, the third switching transistor and the fourth switching transistor, the driver unit stops outputting the first data signal, and the first data line, the second data line, and the third data line do not receive the first data signal.

7. The AMOLED display panel of claim 4, wherein the pixel circuit further comprises: a driving transistor, a light emitting diode, a fifth switching transistor, a sixth switching transistor, and a seventh switching transistor; wherein:
a gate electrode of the driving transistor is connected to a power source via a second capacitor, and a source electrode of the driving transistor is connected to the power source;
a source electrode of the fifth switching transistor is connected to the data line, a drain electrode of the fifth switching transistor is connected to the gate electrode of the driving transistor via a first capacitor, and a first scan signal is applied to a gate electrode of the fifth switching transistor;
a drain electrode of the sixth switching transistor is connected to the drain electrode of the driving transistor, a source electrode of the sixth switching transistor is connected to the gate electrode of the driving transistor, and a second scan signal is applied to a gate electrode of the sixth switching transistor;
a drain electrode of the seventh switching transistor is grounded through the light emitting diode, and a source electrode of the seventh switching transistor is connected to the drain electrode of the driving transistor; and
the fifth switching transistor, the sixth switching transistor, and the driving transistor are PMOS transistors.

8. The AMOLED display panel of claim 7, wherein the seventh switching transistor is a PMOS transistor, and a third scan signal is applied to a gate electrode of the seventh switching transistor.

9. The AMOLED display panel of claim 8, wherein,
in the initialization stage, the control line turns on the first switching transistors, the second data signal outputted from the voltage stabilizer unit is applied to each of the first data line, the second data line and the third data line, in such a way that: the first scan signal turns on the fifth switching transistor, the second scan signal and the third scan signal respectively turn off the sixth switching transistor and the seventh switching transistor, and the first data line, the second data line and the third data line respectively charge the first capacitors via the turned-on fifth switching transistors;
in the data writing stage, the driver unit provides the first data signal to the data lines, and the data writing stage comprises:
a fourth stage, in which the first scan signal turns on the fifth switching transistor, and the second scan signal and the third scan signal respectively turn off the sixth switching transistor and the seventh switching transistor, so that the first data signal outputted from the driver unit is applied to the first data line, but not to the second and third data lines;
a fifth stage, in which the first scan signal turns on the fifth switching transistor, and the second scan signal and the third scan signal respectively turn off the sixth switching transistor and the seventh switching transistor, so that the first data signal outputted from the driver unit is applied to the second data line, but not to the first and third data lines; and
a sixth stage, in which the first scan signal turns on the fifth switching transistor, and the second scan signal and the third scan signal respectively turn off the sixth switching transistor and the seventh switching transistor, so that the first data signal outputted from the driver unit is applied to the third data line, but not to the first and second data lines;
in a light emitting stage, the driving transistor generates a driving current to drive the light emitting diode.

10. The AMOLED display panel of claim 9, wherein the first scan signal, the second scan signal and the third scan signal are independent of each other in timing.

11. The AMOLED display panel of claim 7, wherein the seventh switching transistor is an NMOS transistor, and the first scan signal is applied to a gate electrode of the seventh switching transistor through the connection of the gate electrode of the seventh switching transistor and the gate electrode of the fifth switching transistor.

12. The AMOLED display panel of claim 11, wherein,
in the initialization stage, the control line turns on the first switching transistors so that the second data signal outputted from the voltage stabilizer unit is applied to each of the first data line, the second data line and the third data line, in such a way that: the first scan signal turns on the fifth switching transistor and turns off the seventh switching transistor, and the second scan signal turns off the sixth switching transistor, so that the first data line, the second data line, and the third data line respectively charge the first capacitor via the turned-on fifth switching transistor,
in the data writing stage, the first data signal outputted from the driver unit is applied to the data lines, and the data writing stage comprises:
a seventh stage, in which the first scan signal turns on the fifth switching transistor and turns off the seventh switching transistor, and the second scan signal turns off the sixth switching transistor, so that the first data signal outputted from the driver unit is applied to the first data line, but not to the second and third data lines;
an eighth stage, in which the first scan signal turns on the fifth switching transistor and turns off the seventh switching transistor, and the second scan signal turns off the sixth switching transistor, so that the first data signal outputted from the driver unit is applied to the second data line, but not to the first and third data lines; and
a ninth stage, in which the first scan signal turns on the fifth switching transistor and turns off the seventh switching transistor, and the second scan signal turns off the sixth switching transistor, so that the first data signal outputted from the driver unit is applied to the third data line, but not to the first and second data lines;
in a light emitting stage, the driving transistor generates a driving current to drive the light emitting diode.

13. The AMOLED display panel of claim 12, wherein the first scan signal and the second scan signal are independent of each other in timing.

14. The AMOLED display panel of claim 3, wherein the control line is configured to output a pulse signal.

15. The AMOLED display panel of claim 1, wherein the first data signal is a pulse signal, and the second data signal has a constant level.

16. The AMOLED display panel of claim 15, wherein the first data signal has a lower level in the data writing stage than in the initialization stage.

17. The AMOLED display panel of claim 15, wherein a high level of the first data signal is greater than a low level of the first data signal by 3V or more.

18. The AMOLED display panel of claim 15, wherein a low level of the first data signal is in a range between 0V and 5V.

19. The AMOLED display panel of claim 15, wherein a voltage difference between a level of the second data signal and a low level of the first data signal is greater than or equal to 3V.

20. An organic light emitting diode display device, comprising an AMOLED display panel, wherein the AMOLED display panel comprises:
a plurality of pixel circuits;
a plurality of data lines coupled to the pixel circuits;
a driver unit configured to provide a first data signal;
a multipath selection unit connected between the data lines and the driver unit and configured to transmit the first data signal to the selected data line; and
a voltage stabilizer unit connected to the data lines and configured to output a second signal to the data lines;
wherein, before a data writing stage, the second signal outputted from the voltage stabilizer unit is applied to the data lines.
